(19) United States
(12) Patent Application Publication
(10) Pub. No.: US 2010/0256967 A1
(43) Pub. Date: Oct. 7, 2010

(54) VARIABLE SAMPLE MAPPING ALGORITHM

(75) Inventors: Jeffrey S. Smith, Ellicott City, MD (US); David L. Aronstein, Silver Spring, MD (US); Bruce H. Dean, New Market, MD (US); Richard G. Lyon, Marriottsville, MD (US)

Correspondence Address: NASA GODDARD SPACE FLIGHT CENTER, 8800 GREENBELT ROAD, MAIL CODE 140.1, GREENBELT, MD, 20771, US

(73) Assignee: United States of America as represented by the Administrator of the National Aeronautics and Spac, Washington, DC (US)

(21) Appl. No.: 12/570,224

(22) Filed: Sep. 30, 2009

Related U.S. Application Data
(60) Provisional application No. 61/166,129, filed on Apr. 2, 2009.

(51) Int. Cl. G06F 17/50; G02B 23/02

(52) U.S. Cl. 703/13; 359/350

(57) ABSTRACT

A variable sample mapping algorithm supplements an iterative transform algorithm stored on a computer readable medium. The variable sample mapping algorithm employs data-to-model mapping comprising: modeling a measured data point; modeling estimated additional data corresponding to the measured data point; and adjusting the estimated additional data to include the corresponding measured data point.

The present application claims a benefit from prior U.S. Patent Application No. 61/166,129, filed Apr. 2, 2009, which is incorporated herein in its entirety by reference.

The invention described herein was made by an employee of the United States Government and may be manufactured and used by or for the Government of the United States of America for governmental purposes without the payment of any royalties thereon or therefore.

### FIELD

The present teachings provide a set of modifications or supplements to iterative transform-based algorithms that address optical system characteristics that can cause errors in wavefront recovery. The present teachings also provide a general framework for data-to-model mapping to supplement traditional iterative transform-based algorithms.

### BACKGROUND

The James Webb Space Telescope, an observatory of NASA's Origins program, will employ an image-based wavefront sensing method, in a sense that point source stellar images will be collected and processed to recover optical phase information. The James Webb Space Telescope is an infrared (IR) telescope including a 6.5 meter diameter telescope having a segmented primary mirror that will deploy after it launches. To allow the James Webb Space Telescope's segmented mirror to perform like a single monolithic mirror, a wavefront sensing and control subsystem can be utilized to sense (estimate) and correct any errors (e.g., misalignments) in the segmented mirror's optics. Nine distinct alignment processes (or algorithms) will be used to align the deployed telescope into a high-performance astronomical telescope.

The James Webb Space Telescope will include an Integrated Science Instruments Module (ISIM) that will include a near infrared camera (NIRCam), a near infrared spectrograph (NIRSpec), a mid infrared instrument (MIRI), a tunable filter imager (FGS-TF), and a fine guidance sensor (FGS-Guider). NIRCam is an infrared imager that can have a spectral coverage ranging from the edge of the visible spectrum (0.6 micrometres) through the near infrared spectrum (5 micrometres). The NIRCam will also serve as the James Webb Space Telescope's primary wavefront sensor, which is required for wavefront sensing and control activities.

The NIRCam will assist in phase retrieval for aligning, deploying, and maintaining the James Webb Space Telescope. The NIRCam is designed as a wavefront sensor by incorporating monochromatic filters, Nyquist sampling, and sufficient diversity defocus. Detectors, such as the NIRCam detector, collect only an intensity value, and not phase information of the electric field. Phase retrieval algorithms can be employed to recover the complex electric field when not collected by the detector.

Phase retrieval was first applied practically in 1990 to diagnose mirror problems with the Hubble Space Telescope (HST) and subsequently in 1993 to validate corrective optics used to repair the Hubble Space Telescope. Because the Hubble Space Telescope diagnosis was successful and the deployed Hubble Corrective Optics Space Telescope Axial Replacement (COSTAR) functioned correctly, phase retrieval in general terms has been validated, See Grey et al., Proc. SPIE 1168 (1989) and Lyon et al., Proc. SPIE 1567 (1991). The prior art phase retrieval algorithm used with the Hubble Space Telescope recovered wavefront information using either coupled parametric or iterative-transform phase-retrieval algorithms, spanning images across multiple wavelengths and foci to recover unambiguously the unwrapped phase on parallel computers. A subset of the phase retrieval algorithm used with the Hubble Space Telescope was proposed and studied for the James Webb Space Telescope. See Lyon et al., Optics and Photonics News 9, No. 7 (1998). However, the James Webb Space Telescope has a segmented primary mirror and the Hubble Space Telescope phase-retrieval algorithms were not completely applicable to a segmented primary mirror.

Phase retrieval can be defined as wavefront recovery when stimulating optics with a single point. The output of wavefront recovery can include, for example, a wavemap, a set of Zernicke coefficients, a pupil amplitude (which can be used to determine convergence), and a recovered optical transfer function (OTF) or point spread function (PSF).

The current state of the art for iterative transform phase retrieval algorithms is a Hybrid Diversity Algorithm (HDA), as disclosed in B. H. Dean et al., Results on Fixed Lens Wavefront Sensing, NASA Technical Presentation (Jun. 5, 2003) and B. H. Dean et al., Proc. SPIE 6265, 626511 (2006). The Hybrid Diversity Algorithm was developed to address severe phase-wrapping discontinuities, ambiguous convergence to solutions, and estimation bias in other image-based wavefront sensing methods.

The generic structure of the “core” or “engine” common to all iterative transform algorithms performed on a single image can be described as follows:
1. Start with an estimate of a system wavefront.
2. Simulate propagation of an electric field from the exit pupil to the image plane (via a Fourier transform to get magnitude and phase of the electric field) using either measured or simulated data for the exit pupil light intensity and the current estimate of the system wavefront from step 1. Using the Fresnel approximation to Maxwell's equations, this propagation is performed by evaluating the Fourier transform of the electric field in the exit pupil to calculate the amplitude of the image plane electric field. This propagation, from the exit pupil to the image plane, is referred to as the forward model.
3. Replace the amplitude of the image plane electric field calculated in step 2 with data from point source function measurements (intensity values measured from the detector), but retain the phase and construct a new image plane electric field. Replacing the amplitude with data from point source function measurements is referred to as imposing image plane constraints.
4. Propagate the new image plane electric field back to the exit pupil. To the level of the Fresnel approximation, this propagation is described by an inverse Fourier transform of the image plane electric field, which in practice is numerically evaluated on a second array of sampled values to calculate a second amplitude of the pupil plane electric field. This propagation, from the image plane to the exit pupil, is referred to as the backward model.
5. Replace the amplitude of the pupil plane electric field calculated in step 4 with data from pupil amplitude measurements (which can be directly measured by a pupil imaging lens and/or an image detector) or simulations (which can be obtained, when there is no pupil imaging lens, from an optical model), which is referred to as imposing the pupil plane constraints.
6, Iterate steps 2 through 5 using an output wavefront from step 5 as the input wavefront for step 2 until convergence is reached.

FIG. 1 illustrates the general principal of an iterative transform algorithm phase retrieval process. As can be seen, the diversity data (also referred to as the image plane amplitude or image constraint) and the obscurations (also referred to as the pupil plane amplitude or pupil constraint) cause convergence of the wavefront estimate as the algorithm performs phase retrieval, moving left to right.

Optical systems including telescopes and their accompanied instrument packages may include characteristics that can cause difficulties for phase retrieval. There are a many types of possible shortcomings, at least three of which will be discussed herein: (1) broadband illumination; (2) under-sampled images; and (3) images with a small diversity defocus.

Regarding broadband illumination, prior iterative transform algorithms for phase retrieval used images collected in broadband light but in the phase retrieval model assumed that the illumination was monochromatic in order to exploit the properties of iterative transform. Optical systems using broadband light (or polychromatic illumination) create point spread functions (PSFs, which describe the response of an imaging system to a point source) with blurred higher spatial frequency features. Attempting to determine the optical system wavefront using measured polychromatic point spread functions in a conventional iterative transform algorithm simulating a single wavelength leads to estimation errors that increase with the bandwidth of the light source.

In certain application, the phase retrieval errors introduced by broadband illumination are small when considering recovery of low spatial frequency aberrations. In the prior art, iterative transform phase retrieval has been performed using a single wavelength representing the center of the dominant wavelength of a broadband spectrum, or as a series of discrete wavelength (or monochromatic) phase retrievals, as discussed in B. H. Dean, White Light Phase Retrieval Analysis, presented for the NASA Next Generation Space Telescope Technical Memorandum, NASA/Goddard Space Flight Center, Greenbelt, Md., Oct. 11, 2000. Parametric phase retrieval has been proposed as an alternative method for polychromatic phase retrieval, as discussed in J. Fienup, J. Opt. Soc. Am. A, 16, 1831 (1999). Both of these prior art methods found optimum results when modeling a polychromatic point source function as a discrete sum of monochromatic point source functions. In the prior art iterative transform approach to phase retrieval with broadband illumination, the forward and backward propagation and applied constraints (steps 2-5) are performed for each discrete wavelength. Parametric phase retrieval cannot perform the backward propagation model of step 4 above.

Regarding undersampled images, there is a connection between the size of the pixels used to record an image and the success of phase retrieval algorithms in determining the wavefront. The connections between pixel size and phase retrieval algorithm accuracy can be expressed by the following sampling ratio:

Q=wavelength*f/#1 pixel size

where “f/#” represents a focal ratio, which is a ratio of the focal length to the exit pupil diameter. “Wavelength” represents the wavelength of light passing through the optical system, and “pixel size” represents the lineal size (i.e., the length or the width) of the pixel pitch on the detector. According to the Nyquist-Shannon sampling theorem, Q=2 is needed for proper sampling of images that, when created by a point source of light, are referred to as point spread functions. By exploiting a special mathematical property of a sampled band-limited function, and when applied specifically to a sampled focal plane electric field, existing iterative transform algorithm phase retrieval methods can work well even for Q=1.

In the prior art, point source functions obtained with a sampling parameter of Q<2 were interpolated (up-sampled) up to Q=2 and phase retrieval was then performed using the up-sampled images. Despite numerous known interpolation schemes (e.g., bi-linear, bi-cubic, etc.), up-sampling can frequently lead to phase retrieval errors that tend to increase as the sampling ratio Q falls below 2. The prior art has not performed accurate phase retrieval on images sampled with Q<1.

Regarding small diversity defocus ranges, even for images that are sufficiently sampled for phase retrieval (i.e., Q≧2), phase retrieval has higher accuracy for out-of-focus images than for in-focus images, because defocusing an image tends to spread the information about the wavefront over more pixels, thereby providing a higher sampling of the spatial frequencies needed for phase retrieval. Additionally, defocusing allows longer light-detector integration times to achieve a given signal-to-noise (SNR) ratio. These effects work together to increase the fidelity of wavefront recovery.

Each pixel on a detector measures the average light intensity over the pixel area; this effect can be referred to as the pixel MTF in existing literature. If the point source function changes rapidly over a single pixel (as it does for in-focus images), conventional iterative transform phase retrieval can have compromised accuracy. The prior art does not provide a solution to implementing pixel-averaging effects directly inside an iterative transform phase retrieval algorithm.

Recovery of a wavefront in the prior art can also be performed using an interferometer, which measures the wavefront but requires additional optics and measures wavefront in a different manner than the way the optical system will be used. Employing an interferometer for wavefront measurement increases the weight and complexity of the optical system. Further, an interferometer performs a comparison with a known reference, so that its measurement is only as good as the known reference.

### SUMMARY

A Variable Sample Mapping algorithm (or algorithm supplement) can allow iterative transform-based phase retrieval to achieve higher accuracy by incorporating previously un-modeled detector effects.

In accordance with the present teachings, at least one of the processes (or algorithms) for aligning, deploying, and maintaining the James Webb Space Telescope utilizes an iterative transform algorithm with a Variable Sample Mapping supplement (referred to herein as a Variable Sample Mapping algorithm) in accordance with the present teachings. For example, a multi-instrument, multi-field process can utilize a Variable Sample Mapping algorithm. The multi-instrument, multi-field process typically occurs after fine phasing which, along with the other deployment algorithms, is performed for a single field point. The single field alignment processes (or algorithms) can also be used periodically, for example every two weeks, to maintain alignment of the mirror. The multi-instrument, multi-field process can be performed less frequently, for example annually.

In addition to its applicability for aligning telescopes such as an IR telescope, a Variable Sample Mapping algorithm in accordance with the present teachings has additional uses, for example as an optical metrology tool. A Variable Sample Mapping algorithm can be utilized with additional phase retrieval software in the place of hardware such as an interferometer, particularly in instances when additional analysis is needed. Such additional analysis can be needed in instances of, for example: (1) broadband illumination; (2) under-sampled images; and (3) images with a small diversity defocus. The Variable Sample Mapping algorithm can also be used to address issues such as alignment vibration, figure vibration, charge diffusion, extended objects, chromatic aberration, and detector quantization.

The present teachings provide a method for recovering a wavefront. The method comprises: inputting a wavefront estimate; simulating propagation of first image plane electric fields for selected discrete wavelengths and for sub-pixels of a detector pixel from the exit pupil to the image plane using the wavefront estimate and measured or simulated data for a light intensity of the exit pupil; scaling amplitudes of the first image plane electric fields to correspond with data from point source function estimates to create a second image plane electric field for each of the selected discrete wavelengths and sub-pixels; scaling the amplitude of regions of sub-pixels so that the sum of the flux within a region of sub-pixels equals a measured flux within a physical detector pixel; simulating propagation of the second image plane electric fields from the image plane to the exit pupil; combining the wavefronts for each of the selected discrete wavelengths; applying a pupil plane amplitude constraint to the combined wavefronts to calculate a resulting wavefront; using the resulting wavefront as a new wavefront estimate; and repeating the method steps until convergence is reached.

The present teachings also provide a method for aligning, deploying, and maintaining a segmented primary mirror of an infrared telescope system. The method comprises: inputting a system wavefront estimate; simulating propagation of first image plane electric fields for selected discrete wavelengths and for sub-pixels of a detector pixel from the exit pupil to the image plane using the system wavefront estimate and measured or simulated data for a light intensity of the exit pupil; replacing amplitudes of the first image plane electric fields with data from point source function estimates to create a second image plane electric field for each of the selected discrete wavelengths and sub-pixels; scaling the amplitude of regions of sub-pixels so that the sum of the flux within a region of sub-pixels equals a measured flux within a physical detector pixel; simulating propagation of the second image plane electric fields from the image plane to the exit pupil; combining the wavefronts for each of the selected discrete wavelengths; applying a pupil plane amplitude constraint to the combined wavefronts to calculate a resulting wavefront; using the resulting wavefront as a new system wavefront estimate; and repeating the method steps until convergence is reached.

The present teachings further provide a variable sample mapping algorithm for supplementing an iterative transform algorithm stored on a computer readable medium. The variable sample mapping algorithm employs data-to-model mapping comprising: modeling a measured data point; modeling estimated additional data corresponding to the measured data point; and adjusting the estimated additional data to include the corresponding measured data point.

Additional objects and advantages of the present teachings will be set forth in part in the description which follows, and in part will be obvious from the description, or may be learned by practice of the teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and, together with the description, serve to explain the principles thereof.

### BRIEF DESCRIPTION OF THE DRAWINGS

FIG. 1 illustrates the basic principles of an iterative transform-type algorithm.

FIGS. 2A and 2B illustrate the subtlety of how data-to-model mapping can address undersampled images.

FIG. 3 is a flow chart illustrating the logic underlying a Variable Sample Mapping algorithm in accordance with certain embodiments of the present teachings.

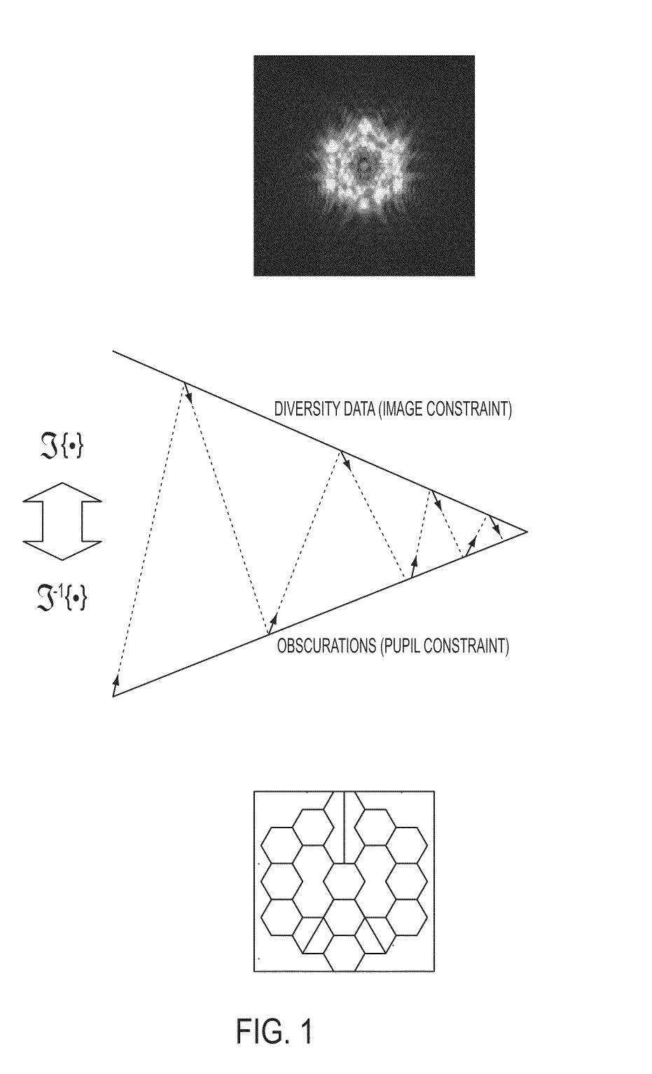

### DESCRIPTION OF THE EMBODIMENTS

Reference will now be made in detail to embodiments of the present teachings, explanations of which are illustrated in the accompanying drawings.

The performance of an optical system, for example a telescope, can be characterized in terms of the wavefront of light traveling through the system, which is the light's phase variations in the exit pupil. Phase retrieval is a methodology for determining (recovering) an optical system's wavefront using images obtained, e.g., from a camera and a light detector, when the system is illuminated with a point source or other light source of known shape and characteristics. Recovering the wavefront of an optical system can include determining phase variations in a light wave passing through the system that are synonymous with aberrations, misalignments, or imperfections in the system. Although iterative phase retrieval was limited in the prior art to wavefront recovery when simulating optics with a single point, a Variable Sample Mapping algorithm in accordance with the present teachings can perform wavefront recovery for more than one point.

Unlike known interferometric methods, phase retrieval is an image-based method for determining (or sensing) the wavefront. Indeed, this procedure may be in direct contrast to more conventional interferometric methods, which require additional complex and expensive hardware. Phase retrieval trades software for hardware. It is used both as an optical metrology tool (during fabrication of optical surfaces and assembly of optical systems) and as a system for wavefront sensing and control for actively adjustable optical systems.

There are two classes of phase retrieval algorithms that can collect wavefront information: (1) iterative transform algorithms; and (2) parametric algorithms. The present teachings focus on iterative transform algorithms, which estimate the optical wavefront by iteratively enforcing known constraints in Fourier conjugate domains (pupil and image-plane, respectively).

A Variable Sample Mapping algorithm in accordance with the present teachings can supplement an iterative transform algorithm to perform optical wavefront estimation for under-sampled optical systems and incorporates additional detector blurring functions in the estimation process. Including these additional effects can help remove some estimation bias, resulting in more accurate phase estimation.

In certain embodiments of the present teachings, the Variable Sample Mapping algorithm can comprise a data-to-model mapping technique that is built into the core of a Misell-Gerchberg-Saxton algorithm. In the Variable Sample Mapping algorithm's data-to-model mapping technique, electric fields at multiple wavelengths of light are modeled inside of an associated phase retrieval algorithm with high fidelity. The electric fields can then be mapped to a light intensity profile consistent with the properties of the light detector and the data. The data-to-model mapping technique facilitates a more robust and accurate way of incorporating pupil-plane constraints and image-plane constraints into the iterative transform algorithm.

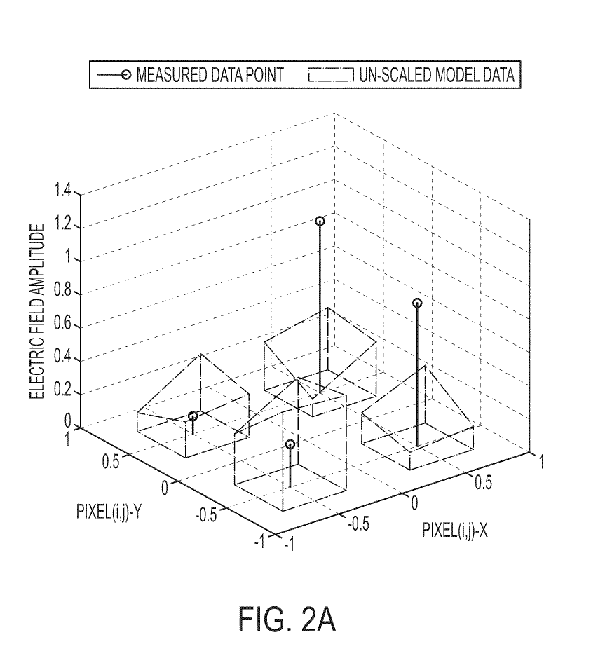

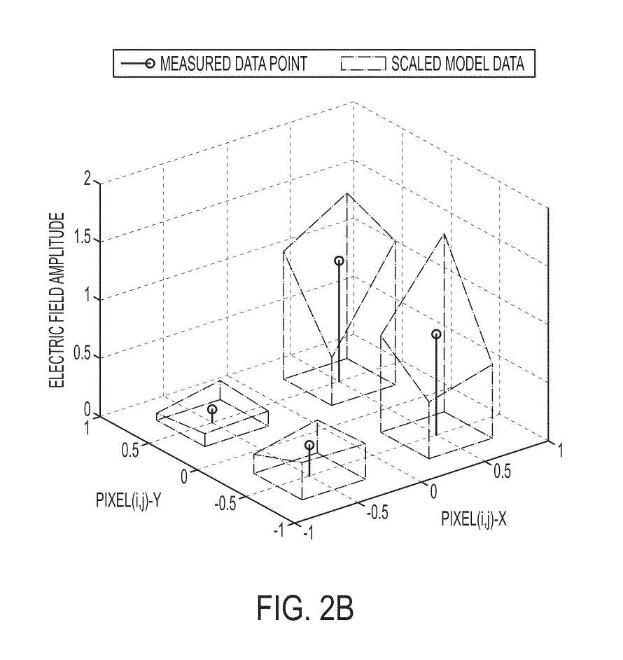

FIGS. 2A and 2B illustrate the subtlety of how data-to-model mapping can address undersampled images. In FIG. 2A, the circles represent a measured data point and the surrounding boxes represent associated unsealed model data for each measured data point. FIG. 2B illustrates that data-to-model mapping scales the sum of the estimate (model data) for each measure data point to the measured data point (i.e., raising and lowering the surrounding boxes).

Data-to-model mapping, as referred to herein, therefore includes a modeled estimate of an actual data point and a corresponding model of what the electric field should be for that data point (the boxes surrounding each actual data point). The modeled data in the surrounding boxes is then adjusted to include the actual data as shown in FIG. 2B for every pixel. In accordance with such a data-to-model mapping embodiment, a 1000×1000 camera would have a modeled electric field that is N*1000×N*1000, where N is an integer. Thus, every actual data point would have N*N modeled points. In FIG. 2B, N is 2. As would be understood by those skilled in the art, data-to-model mapping therefore provides higher fidelity than collected samples would otherwise provide, which can be particularly useful when pixels in a detector are relatively large and sampling cannot be performed with suitable fineness. This differs from prior art modeling, wherein each actual data point has only a single corresponding data point in the model.

To ensure alignment of the James Webb Space Telescope over its entire field of view, phase retrieval must be performed using images from the instruments of the James Webb Space Telescope's ISIM. Phase retrieval was not considered in the design of ISIM instruments other than the NIRCam. Prior art phase retrieval algorithms were not suitably capable of accurately recovering the wavefront from images collected with the other ISIM instruments. However, phase retrieval algorithms can be modified to accommodate the less-than-optimal images from the other ISIM instruments. The Variable Sample Mapping algorithm of the present teachings is capable of accurately recovering the wavefront from images from all of the ISIM instruments.

The basic principles of a Variable Sample Mapping algorithm in accordance with the present teachings can be divided into two separate ideas. If a phase retrieval algorithm has perfect knowledge of all of the parameters that describe an optical system, the following should hold true:
(a) Stability: If the algorithm is provided the “true” system wavefront (or solution) as the initial starting guess (i.e., the true wavefront is input to the algorithm's first iteration), the algorithm wavefront should be stable at each algorithm iteration. The algorithm wavefront therefore should not change from its starting point and should stay at the “true” system wavefront.
(b) Convergence: A phase retrieval algorithm should always converge to the “true” system wavefront independently of the initial guess; that is, the final determination of the system wavefront should be independent of the starting guess.

A Variable Sample Mapping algorithm provides an open framework for addressing a wide range of issues that can be detrimental to high-accuracy phase retrieval, although it was originally developed with three issues in mind: (1) broadband illumination of an optical system; (2) undersampled images; and (3) small diversity defocus ranges.

As stated above, the core of an iterative transform phase retrieval consists of: (1) propagating a forward model; (2) imposing image plane constraints; (3) inverse propagating a backward model; (4) imposing pupil plane constraints; and (5) iteratively cycling steps 1-4 until a stable solution is reached. A Variable Sample Mapping algorithm in accordance with the present teachings includes a modification of core iterative transform algorithm steps 2, 3, and 4 described in more detail below. In the description that follows, a Variable Sample Mapping algorithm in accordance with the present teachings is explained in three ways: (1) how it addresses broadband illumination; (2) how it addresses undersampled images; and (3) how it addresses other possible issues.

Broadband Illumination

As stated above, prior art methods for phase retrieval of broadband illumination found optimum results when modeling a polychromatic point source function as a discrete sum of weighted monochromatic point source functions.

A Variable Sample Mapping algorithm in accordance with the present teachings can be used in conjunction with a Fast Fourier Transform (FFT) or a Discrete Fourier Transform (DFT, a more general form of the FFT), to calculate polychromatic electric fields. While an FFT can require less computation than a DFT, a DFT can utilize less memory than an FFT. Thus, utilizing a DFT can be faster for some cases. An advantage of using a DFT is that it can be used for propagating fields such that cropping or padding errors can be avoided in addition to interpolation errors. A downside to using a OFT for propagating fields is that it has increased computational and possibly memory requirements. Furthermore, the FFT and inverse FFT are closed form, but the inverse DFT is not closed form, and thus the inverse DFT does not completely undo the DFT, so that small errors could result when utilizing the DFT—but not when used in conjunction with the Variable Sampling Algorithm. The optimal choice (FFT or DFT) for use in conjunction with the Variable Sampling Algorithm for propagation is likely to be application-specific.

A Variable Sample Mapping algorithm in accordance with the present teachings also simulates light at several different wavelengths traveling between the exit pupil of the optical system and the image plane. However, rather than using broadband data with a monochromatic phase retrieval model as in the prior art, the Variable Sample Mapping algorithm can use a data-to-model mapping procedure as discussed above to combine images at the discrete wavelengths traveling through the optical system. The wavelengths can, for example, be selected to sufficiently sample the source and optical transmission spectrum. This could include, for example one wavelength or more, as needed. For example, for FGS, a spectrum range of 0.8 micrometers to 5.0 micrometers of bandwidth can be utilized, and 5-10 wavelengths can be sufficient to sample the spectrum. The images at discrete selected wavelength are combined into a single polychromatic point source function that can be compared with the measured data from data-to-model mapping.

True light sources contain a continuous range of wavelengths. In a Variable Sample Mapping algorithm in accordance with the present teachings, steps 2-4 are performed on multiple (discrete) wavelengths chosen as a subset of the continuous true light source range. For step 2, the forward model in accordance with the present teachings is used with each discrete chosen wavelength separately. For step 3, the summing used to compare against measured images is done over three dimensions: (1) the sub-pixels in a first direction; (2) the sub-pixels in a direction orthogonal to the first direction; (3) the discrete wavelengths propagated. For step 4, the discrete chosen wavelengths are propagated through the backward model separately. The Variable Sample Mapping algorithm seeks a single unique wavefront describing the optical system, but each wavelength has its own wavefront during step 5. To obtain the sought single unique wavefront, the Variable Sample Mapping algorithm combines the set of wavefronts from step 5, one per discrete wavelength, into a single answer using, for example, a straight average or weighted average based on the relative intensities of different wavelengths in the illuminations. This approach assumes that the wavefronts associated with a given wavelength are the same. For mirrored and well-corrected glass optical systems, this can be a reasonable assumption. For a polychromatic aberration, the Variable Sampling Mapping algorithm removes the chromatic aberration from each wavefront that corresponds to the various wavelengths before it combines them.

Undersampled Images

Regarding undersampled images, one issue addressed by a Variable Sample Mapping algorithm in accordance with the present teachings is the ability to perform accurate phase retrieval on images sampled with Q<1.

As explained above, an image is undersampled for phase retrieval if the optical system's sampling parameter Q is less than 1. For a given optical system's focal ratio f/# and illumination wavelength, a sampling ratio is decided by the pixel size of the detector. A Variable Sample Mapping algorithm in accordance with the present teachings incorporates undersampled images by simulating the use of smaller pixels (sub-pixels) during forward propagation (step 2), and can therefore incorporate use of sampling ratios of Q>1 internal to the algorithm. Then, rather than replacing the amplitude of the image-plane electric field (step 3), a Variable Sample Mapping algorithm in accordance with the present teachings scales the amplitude of regions of simulated smaller pixels (or sub-pixels), such that the sum of the flux within a region of oversampled pixels (or sub-pixels) equals the measured flux within the larger physical detector pixel. Finally, for the backward propagation model (step 4), the Variable Sample Mapping algorithm again models the propagation of light from the simulated smaller pixels rather than from larger physical detector pixels. Even when the measured point source function data is collected with Q<1, the simulated Q inside a Variable Sample Mapping algorithm in accordance with the present teachings can be greater than 1, and thus the backward propagation model does not suffer from aliasing. Aliasing occurs when inaccurate results are obtained from sampling that does not occur frequently enough. However, there are effects due to aliasing from the measured image being undersampled that are in the process of being quantified. The Variable Sample Mapping algorithm can thus be considered a way to connect high-fidelity computer simulations of light propagation with measurements made in less than ideal situations.

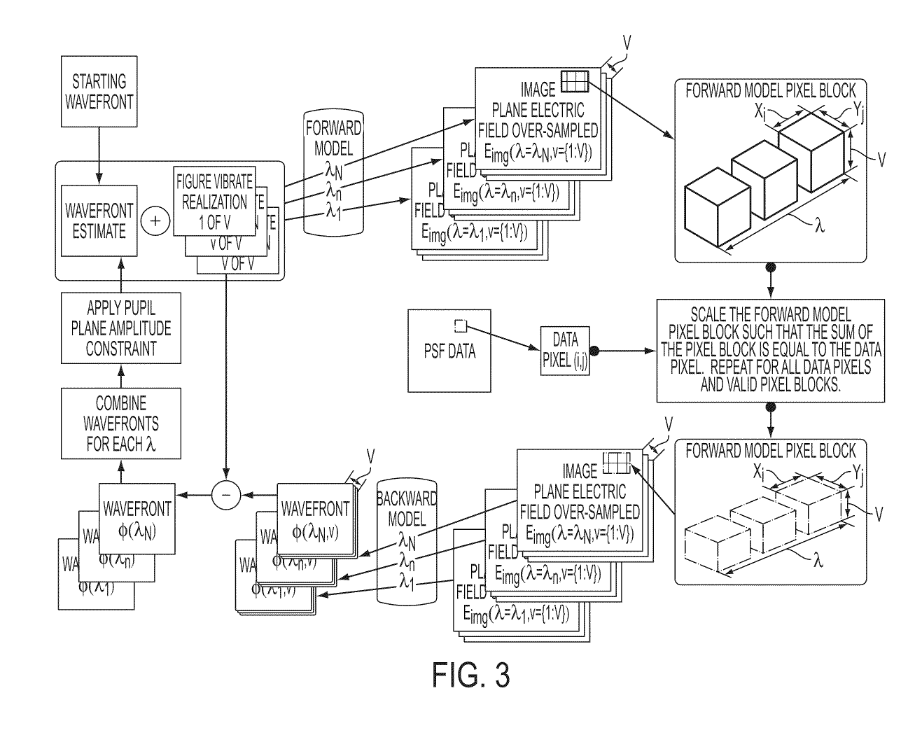

For example, in an optical system having data collected with Q=0.75, a Variable Sample Mapping algorithm in accordance with the present teachings can evaluate the forward propagation model to simulate light propagation with a sampling ratio of Q′>1. While it is convenient to work with an integer multiple of the true sampling ratio, using an integer is not necessary. In this example, let Q′=2Q=1.5. This implies that the simulated light propagates to the detector with a pixel size that is half that of the real detector used to collect the data. During forward propagation (step 2), the Variable Sample Mapping algorithm oversamples the image plane electric field by two in the x and y directions (see FIGS. 2A, 2B, and 3). In other words, the electric field is calculated at twice the number of points in each direction than the actual detector measures. Thus, there are 4 simulated sub-pixels for each measured pixel. In step 3, the flux value for the 4 sub-pixels is scaled (multiplied) by the constraint value, so that the sum of the flux equals the observed value of the flux in the observed data pixel. In the backward propagation model (step 4), this scaled, oversampled image plane electric field is used to propagate the simulated light back to the exit pupil. Traditionally, before the Variable Sample Mapping algorithm, backward propagation would be aliased since Q<1. Now, since Q′=1.5 inside the simulation, the oversampled image plane electric field is not aliased.

This technique of summing the values of oversampled sub-pixels for comparison with measured pixel data can account for additional behavior that has not been addressed by prior art iterative transform algorithms—namely, that a detector pixel records the average light intensity as integrated over the finite area of its surface.

Although oversampling in the image plane is discussed above, the present teachings contemplate a similar technique being applied to the exit pupil amplitude.

This method differs from prior art methods that up-sample the image plane electric field to a value of Q=2, because such prior art methods replace a single modeled sub-pixel with a corresponding data pixel, thus imposing an image plane amplitude constraint only where valid data is available. This prior art method avoids aliasing in backward propagation but is not sufficiently general to model a pixel modulation transfer function effect in the up-sampling process.

For broadband and/or undersampled scientific instruments, there is limited ability to recover high-order aberrations. If an instrument is undersampled, frequencies above a predetermined limit cannot be recovered. Therefore, if it is known going in that an image is undersampled, results from frequencies above the predetermined limit can be discarded.

Small Diversity Defocus Ranges

Regarding small diversity defocus ranges, if the point source function changes rapidly over a single pixel (as it does for in-focus images), a Variable Sample Mapping algorithm in accordance with the present teachings offers two distinct approaches to model the resulting “pixel averaging effect.” One way utilizes a binning process inherent to the Variable Sample Mapping algorithm's data-to-model mapping technique. The binning process is identical to the process described above, for example using a Q′>2 to over-sample the electric field beyond the critical sampling rate. The other way utilizes a modulation transfer function (MTF) approach to estimate pixel averaging. For this method, the modeled electric field with Q>2 can be convolved with the known modulation transfer function. This convolution can occur in the spatial domain as a convolution or in the frequency domain as multiplication. Both approaches offer an advantage over the prior art, with the choice between the approaches being an application-specific decision, trading computational and memory demands with phase retrieval accuracy. In general, rebinning requires more memory, and MTF requires more computation. Depending on the desired level of accuracy, either method may be faster. For increased accuracy using rebinning, Q′ is increased and memory is likewise increased for the larger array sizes. For increased accuracy using MTF, the window of the data increased. Array sizes being equal, the MTF approach requires more computation, because it requires two 2D Fourier Transforms and a multiplication. Rebinning, however, only requires a sum. An important effect can be the amount of defocus used, as more defocus requires larger windows around the data, and thus, more memory for the MTF.

If scientific instruments are defocused, such defocusing can introduce additional wavefront error that has not been modeled. A Variable Sample Mapping algorithm in accordance with the present teachings can recover this wavefront error using multiple defocus images via modeling.

Other Issues

A Variable Sample Mapping algorithm in accordance with the present teachings can address a wide range of image plane and exit pupil effects that were previously considered detrimental to high-accuracy phase retrieval, some examples of which follow. Generally, this can be accomplished by modeling a given effect just prior to finding a transfer function (or scaling factors) in comparing propagated fields with measured data.

Alignment and Figure Vibration: Vibration can be defined as the motion of optical elements that occurs on a time scale faster than the capture rate of the camera. Alignment vibration is the global motion of all optical elements collectively, and figure vibration is the motion of individual optical elements. Alignment vibration is also referred to as line-of-sight motion. Alignment vibration can be modeled either in the exit pupil plane or as part of forward and backward propagation models. Figure vibration, however, can only be modeled in the exit pupil plane. To model vibration in the exit pupil plane, a Variable Sample Mapping algorithm in accordance with the present teachings creates multiple realizations of the vibration mode in the exit pupil plane. For each realization, the Variable Sample Mapping algorithm adds the starting phase estimate from step 1. Next, for each realization, the Variable Sample Mapping algorithm uses a forward model to generate an image plane electric field. Comparison with the measured image plane data (step 3) is accomplished by summing as many as four dimensions, including sub-pixels in a first direction, sub-pixels in a direction orthogonal to the first direction, the discrete wavelengths propagated, and vibration realizations.

To incorporate alignment vibration (line-of-sight motion) in forward and backward propagation models rather than in the exit pupil plane, the line-of-sight motion kernel can be convolved and then devolved with the image plane electric field. This method is preferably applied to critically sampled simulated point spread functions (i.e., Q≧2). Convolution can be incorporated as either a traditional convolution or as a Fourier domain multiplication.

Charge Diffusion: Charge diffusion is a characteristic of a detector where photons arrive at one pixel, but are measured in neighboring pixels. Similar to implementing alignment vibration in forward and backward propagation models, detector charge diffusion can be implemented using a convolution kernel in the forward and backward propagation models.

Extended Objects: Extended objects are when light is emitted from multiple points with varying intensity rather than a single point. Knowledge of extended objects can be incorporated in step 3 by utilizing convolution in the image plane with a known extended object shape. Depending on the shape and intensity of the source, issues surrounding extended objects can be modeled as a coherent convolution or an incoherent convolution, involving the electric field or the intensity, respectively.

Detector quantization: Detector quantization is implemented in step 3 of a Variable Sample Mapping algorithm in accordance with the present teachings, after summing up contributions from sub-pixels, wavelengths, vibration realizations, etc., and before determining scaling factors for the individual electric fields being propagated in its forward and backward propagation models. In a preferred embodiment of the present teachings, detector quantization should not be applied to individual electric fields propagated forward and backward in the simulation, as that would lead to a violation of the stability criteria of the algorithm.

One skilled in the art will understand that the basic principles of a Variable Sample Mapping algorithm in accordance with the present teachings can be used for wavefront recovery in the presence of other aberrations or known optical behavior such as, for example, chromatic aberration. For chromatic aberration, a model can be incorporated that sets forth how the wavefront varies with the wavelength. Similarly, the optical behavior of dispersive elements in the presence of broadband light can be incorporated in a similar fashion.

FIG. 3 is a block diagram representing an exemplary embodiment of a Variable Sample Mapping algorithm supplement to an iterative transform phase retrieval algorithm. The diagram moves in a clockwise, generally circular direction, starting at the upper left corner of the Figure. As can be seen, a “starting wavefront” is input as an estimate of the system wavefront. The starting wavefront can comprise, for example, a value from a prior run of the algorithm, an educated guess, or a random number. Figure vibration realization can then be added to the wavefront (as described hereinabove). Forward model propagation can then be performed to obtain an oversampled image plane electric field that is modeled in the data-to-model mapping of the Variable Sample Mapping algorithm. The forward model pixel block is then scaled using a data pixel from point source function data, such that the sum of the pixel block is equal to the actual data pixel (as shown in FIG. 2B). This scaling is repeated for all of the data pixels and valid pixel blocks, and imposes image plane constraints.

Backward propagation can then be performed for the resulting oversampled image plane electric field after data-to-model mapping occurs. The wavefronts φ for each wavelength λ recovered from the backward model can be combined and a pupil plane constraint can be applied to the combined wavefronts. The resulting constrained wavefront becomes the starting wavefront estimate for the next iteration. It should be noted that the adaptation of the Hybrid Diversity Algorithm can be applied to the wavefront after pupil plane constraints are applied and before the wavefront becomes the wavefront estimate for the next iteration. The Hybrid Diversity Algorithm performs such functions as multi-wave phase recovery, multiple image registration, and focus-diverse phase retrieval.

A Variable Sample Mapping algorithm in accordance with the present teachings is intended for incorporation into a variety of iterative transform-type algorithms.

One skilled in the art will understand that a Variable Sample Mapping algorithm in accordance with the present teachings includes applying amplitude constraints. An iterative transform algorithm has other applications in addition to wavefront recovery as discussed above. For example, a Variable Sample Mapping algorithm in accordance with the present teachings could be used with an iterative transform algorithm to recover pupil amplitude. Determining convergence is one reason for recovering pupil amplitude. In some cases, recovering pupil amplitude is needed for understanding the behavior of the optical system during testing, similar to wavefront recovery.

One skilled in the art will also appreciate that other commercial applications for a Variable Sample Mapping algorithm in accordance with the present teachings will include: (1) laboratory metrology instruments to replace interferometers used for testing optical surfaces and aligning optical elements in a system; (2) microscopy where multiple broadband images are collected in three dimensions via defocusing such that a given plane is in focus; (3) LASIK for the human eye, whereby higher resolution and broadband wavefronts are required for more accurate correction of a human cornea; and (4) radio telescopes in addition to optical telescopes.

Other embodiments of the present teachings will be apparent to those skilled in the art from consideration of the specification and practice of the teachings disclosed herein. It is intended that the specification and examples be considered as exemplary only, with a true scope and spirit of the present teachings being indicated by the following claims.

What is claimed is:

1. A method for recovering a wavefront, the method comprising:
inputting a wavefront estimate;
simulating propagation of first image plane electric fields for selected discrete wavelengths and for sub-pixels of a detector pixel from the exit pupil to the image plane using the wavefront estimate and measured or simulated data for a light intensity of the exit pupil;
replacing amplitudes of the first image plane electric fields with data from point source function estimates to create a second image plane electric field for each of the selected discrete wavelengths and sub-pixels;
scaling the amplitude of regions of sub-pixels so that the sum of the flux within a region of sub-pixels equals a measured flux within a physical detector pixel;
simulating propagation of the second image plane electric fields from the image plane to the exit pupil;
combining the wavefronts for each of the selected discrete wavelengths;
applying a pupil plane amplitude constraint to the combined wavefronts to calculate a resulting wavefront;
using the resulting wavefront as a new wavefront estimate; and
repeating the method steps until convergence is reached.

2. The method of claim 1, wherein simulating propagation of the first image plane electric fields comprises using a Fresnel approximation to Maxwell's equation.

3. The method of claim 2, wherein using a Fresnel approximation to Maxwell's equation comprises evaluating the Fourier transform of the first image plane electric fields in the exit pupil.

4. The method of claim 1 wherein, when the amplitude of the image plane electric fields is scaled, the phase is retained and the second image plane electric fields are created.

5. The method of claim 1, wherein simulating propagation of the second image plane electric fields comprises propagation described by an inverse Fourier transform of the second image plane electric fields.

6. The method of claim 1, comprising simulating propagation of the first and second image plane electric fields at each discrete wavelength.

7. The method of claim 1, comprising recovering a wavefront for undersampled images with Q<1.

8. The method of claim 1, wherein scaling the amplitude of the first image plane electric fields comprises summing to compare the first image plane electric fields to measured images over three dimensions.

9. The method of claim 8, wherein the three dimensions include sub-pixels in a first direction, sub-pixels in a direction orthogonal to the first direction, and the discrete wavelengths propagated.

10. A method for aligning, deploying, and maintaining a segmented primary mirror of an infrared telescope system, the method comprising:
inputting a system wavefront estimate;
simulating propagation of first image plane electric fields for selected discrete wavelengths and for sub-pixels of a detector pixel from the exit pupil to the image plane using the system wavefront estimate and measured or simulated data for a light intensity of the exit pupil;
replacing amplitudes of the first image plane electric fields with data from point source function estimates to create a second image plane electric field for each of the selected discrete wavelengths and sub-pixels;
scaling the amplitude of regions of sub-pixels so that the sum of the flux within a region of sub-pixels equals a measured flux within a physical detector pixel;
simulating propagation of the second image plane electric fields from the image plane to the exit pupil;
combining the wavefronts for each of the selected discrete wavelengths;
applying a pupil plane amplitude constraint to the combined wavefronts to calculate a resulting wavefront;
using the resulting wavefront as a new system wavefront estimate; and
repeating the method steps until convergence is reached.

11. The method of claim 10 wherein, when the amplitude of the image plane electric fields is scaled, the phase is retained and the second image plane electric fields are created.

12. The method of claim 10, comprising simulating propagation of the first and second image plane electric fields at each discrete wavelength.

13. The method of claim 10, comprising recovering a wavefront for undersampled images with Q<1.

14. The method of claim 10, wherein replacing the amplitude of the first image plane electric fields comprises summing to compare the first image plane electric fields to measured images over three dimensions.

15. The method of claim 14, wherein the three dimensions include sub-pixels in a first direction, sub-pixels in a direction orthogonal to the first direction, and the discrete wavelengths propagated.

16. A variable sample mapping algorithm for supplementing an iterative transform algorithm stored on a computer readable medium, the variable sample mapping algorithm employing data-to-model mapping comprising:
modeling a measured data point;
modeling estimated additional data corresponding to the measured data point; and
adjusting the estimated additional data to include the corresponding measured data point.

17. The variable sample mapping algorithm of claim 16, comprising implementing a pixel averaging effect in the iterative transform algorithm.

18. The variable sample mapping algorithm of claim 16, wherein the pixel averaging effect utilizes a binning process.

19. The variable sample mapping algorithm of claim 16, wherein the pixel averaging effect utilizes a modulation transfer function approach to estimate pixel averaging.

20. The variable sample mapping algorithm of claim 16, wherein each measured data point has four corresponding estimated additional data points.
